(19) United States
(12) Patent Application Publication
(10) Pub. No.: US 2016/0153079 A1
(43) Pub. Date: Jun. 2, 2016

(54) Process for Manufacturing an Ophthalmic Lens by Impregnation of a Benzotriazole Derivative

(71) Applicant: ESSILOR INTERNATIONAL (COMPAGNIE GENERALE D'OPTIQUE), Charenton Le Pont (FR)

(72) Inventor: Chafik HABASSI, Charenton le Pont (FR)

(73) Assignee: ESSILOR INTERNATIONAL (COMPAGNIE GENERALE D'OPTIQUE), Charenton le Pont (FR)

(21) Appl. No.: 14/903,030

(22) PCT Filed: Jun. 19, 2014
(86) PCT No.: PCT/FR2014/051518

§ 371 Date: Jan. 5, 2016

(30) Foreign Application Priority Data
Jul. 5, 2013 (FR) 13 56617

(51) Int. Cl. C23C 2/04; G02C 7/10

(52) U.S. Cl. CPC C23C 2/04; G02C 7/108

(57) ABSTRACT

The present invention relates to a process for manufacturing an ophthalmic lens comprising a UV-absorbent transparent organic substrate, comprising submerging the organic substrate in a bath consisting of an aqueous solution containing a 2-(2-hydroxy-4-alkyloxyphenyl)-2H-benzotriazole, in which the alkyl group is linear or branched and contains 3 to 12 carbon atom

### TECHNICAL FIELD

The present invention relates to a process for the manufacture of an ophthalmic lens comprising a transparent organic substrate which absorbs UV (ultraviolet) radiation, comprising the dipping of the organic substrate in a bath consisting of an aqueous solution including a 2-(2-hydroxy-4-alkyloxyphenyl)-2H-benzotriazole where the alkyl group is linear or branched and includes from 3 to 12 carbon atoms.

### BACKGROUND OF THE INVENTION

UV rays with a wavelength of between 200 and 400 nm are known to be harmful to the human eye. They are in particular responsible for an acceleration in ocular aging capable of resulting in an early cataract or more extreme phenomena, such as photokeratitis or “snow blindness”. In order to prevent ocular damage caused by these rays, UV absorbers are normally incorporated in ophthalmic lenses. These UV absorbers can introduced into an abrasion-resistant coating applied to the substrate of the lens (WO 2008/087741) or more generally into the substrate itself. In the latter case, the UV absorber can be incorporated in the body of the lens, during the polymerization of the monomers forming the material of the lens, or at the surface of the latter, by dipping the lens (or impregnation) in a bath containing the UV absorber.

The incorporation of a UV absorber in the lens it is generally accompanied by an undesirable yellowing of the latter, which can be overcome by combining the UV absorber with a specific dye.

The application EP 1 085 348 discloses a process for the incorporation of a UV absorber in a lens without resulting in yellowing of the latter. This process consists in mixing a benzotriazole-based UV absorber with a monomer of episulfide or diethylene glycol bis(allyl carbonate) type, which is subsequently polymerized in order to form the material of the lens. The use of this specific UV absorber in this particular process makes possible absorption of long UV radiation.

In addition, there has been suggested, in the application JP01-230003, a process for the impregnation of a lens using another benzotriazole derivative, 2-(2-hydroxy-5-methylphenyl)benzotriazole.

The need nevertheless remains to have available a simple and effective process for obtaining a lens simultaneously exhibiting a UV cutoff of greater than or equal to 365 nm and a yellowness index YI of less than or equal to 1.5.

The applicant company has demonstrated that this need could be met by incorporating, by impregnation, a 2-(2-hydroxy-4-alkyloxyphenyl)benzotriazole in an ophthalmic lens.

It has already been suggested, in the application JP2006-098564, to use a compound of this type as additive in a coloring liquid intended for the manufacture of a highly colored and scattering lens for a transmission screen. On the other hand, to the knowledge of the applicant company, it has never yet been suggested that this compound could make possible the manufacture of an ophthalmic lens, by nature not very colored and nonscattering, exhibiting the abovementioned properties.

### SUMMARY OF THE INVENTION

A subject matter of the present invention is consequently a process for the manufacture of an ophthalmic lens comprising a transparent organic substrate which absorbs UV radiation, comprising the dipping of the organic substrate in a bath consisting of an aqueous solution including a 2-(2-hydroxy-4-alkyloxyphenyl)-2H-benzotriazole where the alkyl group is linear or branched and includes from 3 to 12 carbon atoms.

Another subject matter of the invention is the use of a bath, consisting of an aqueous solution including an effective amount of 2-(2-hydroxy-4-alkyloxyphenyl)-2H-benzotriazole where the alkyl group is linear or branched and includes from 3 to 12 carbon atoms, in order to confer, on an ophthalmic lens, a UV cutoff of greater than or equal to 365 nm and a yellowness index YI of less than or equal to 1.5 and preferably of less than 1, indeed even of less than 0.8.

### DETAILED DESCRIPTION

The process according to the invention comprises the impregnation of a transparent organic substrate using a specific UV absorber. The term “transparent” is understood to mean a substrate which transmits light without scattering it.

This organic substrate can be any afocal or correcting organic substrate commonly used in the optical and in particular ophthalmic field. Mention may be made, by way of examples, of substrates made of polycarbonate, of polyamide, of polyimide, of polysulfone, of copolymers of poly(ethylene terephthalate) and polycarbonate, of polyolefins, in particular of polynorbornene, of homopolymers and copolymers of polyol allyl carbonates, in particular diethylene glycol bis(allyl carbonate), of polymers and copolymers of alkyl (meth)acrylates or aromatic (meth)acrylates which are polyethoxylated, in particular bisphenol A derivatives, of thio(meth)acrylic polymers and copolymers, of poly(thio)urethane, of epoxy polymers and copolymers and of episulfide polymers and copolymers. It is preferable according to the invention to use a substrate having a refractive index of less than 1.6 and which generally exhibits a UV cutoff of less than 360 nm, such as a substrate consisting of a diethylene glycol bis(allyl carbonate) homopolymer or copolymer.

This substrate is impregnated with UV absorber by dipping the organic substrate in a bath consisting of an aqueous solution of the UV absorber. The latter is chosen from 2-(2-hydroxy-4-alkyloxyphenyl)-2H-benzotriazoles in which the alkyl group is linear or branched and includes from 3 to 12 carbon atoms, preferably from 6 to 10 carbon atoms. It is advantageously an octyl group. The UV absorber can be present in the bath in a concentration of between 0.1 and 5% by weight and preferably of between 0.5 and 1% by weight, with respect to the total weight of the bath. In addition, this bath can contain at least one additive chosen from the group consisting of: a dispersing agent, such as dodecylbenzenesulfonic acid or its salts or an ethoxylated fatty acid ester; a dye, such as those sold by Huntsman under the Teratop Blue NFB and Teratop Red NFR trade names; a pigment; and their mixtures. The duration of dipping of the lens in the bath can be between 30 minutes and 3 h and the temperature of the bath is advantageously between 80° C. and 99° C., preferably between 90° C. and 96° C.

After impregnation, the ophthalmic lens can be rinsed with water or using a lower alcohol, such as ethanol or isopropanol.

It can subsequently be coated with different coatings and in particular with the stack of one or more coatings chosen from: an abrasion-resistant coating, an antireflective coating, an antisoiling coating, an antistatic coating, an antifog coating, a polarizing coating, a tinted coating and a photochromic coating.

The lens generally comprises at least one abrasion-resistant coating positioned on the substrate, either directly or after interposition of a latex-based impact-resistant primer coating. This abrasion-resistant coating can be formed from alkyl (meth)acrylate but it is preferably formed by the sol-gel route starting from at least one epoxyalkoxysilane and optionally from at least one alkoxysilane, as described in the application EP 0 614 957, for example.

In addition, the abrasion-resistant coating can include at least one component chosen from: a solvent, such as methanol; a condensation catalyst, such as a compound including several carboxylic acid or carboxylic anhydride functional groups, preferably itaconic acid or, in an alternative form, trimellitic acid or trimellitic anhydride; a curing catalyst, such as an aluminum-based compound, in particular aluminum acetylacetonate, dicyandiamide or their mixtures; a fluorinated or siliconated surfactant; an inorganic filler, such as silica, in the form of a colloidal suspension in a solvent, such as water and/or an alcohol; a chelating agent; a UV absorber; and their mixtures.

The abrasion-resistant coating can be applied to the substrate according to known processes, for example by spin coating, by dip coating, by bar coating or by spray coating, preferably by spin coating. Preferably, the deposition is carried out by dip coating.

After application to the substrate, this coating can be cured by heating in an oven or by infrared, typically at a temperature of 60° C. to 200° C., for example of 80° C. to 150° C., for a period of time of 30 min to 3 hours.

Optionally, an antireflective coating can subsequently be applied above the abrasion-resistant coating, according to the same coating processes. Antireflective coatings are well known and conventionally comprise a monolayer or multilayer stack of dielectric materials, such as SiO, SiO₂, Al₂O₃, MgF₂, LiF, Si₃N₄, TiO₂, ZrO₂, Nb₂O₅, Y₂O₃, HfO₂, Sc₂O₃, Ta₂O₅, Pr₂O₃ and their mixtures. It is preferable to use a multilayer stack comprising an alternation of inorganic dielectric layers of high refractive index (RI>1.55) and of low refractive index (RI<1.55), the latter advantageously comprising a mixture of SiO₂ and Al₂O₃.

On conclusion of this process, an ophthalmic lens is obtained which is intended to protect the eye and/or to correct the vision and fits a spectacle frame.

This lens exhibits a UV cutoff of greater than or equal to 365 nm and a yellowness index YI of less than or equal to 1.5 and preferably of less than 1, indeed even of less than 0.8.

The UV cutoff corresponds to the wavelength for which the transmission of the light is less than 1%, for a substrate with a thickness of 2 mm and under normal incidence. It can be measured using a spectrophotometer.

The protective power of the lens with regard to UV radiation can, in an alternative form, be expressed by its RUVa content, which corresponds—in accordance with the standard ISO 4007:2012—to the standardized value (as percentage) of the spectral transmission factor averaged between 315 and 380 nm, weighted by the distribution of the solar spectral power, Es(λ), at sea level, for an air mass of 2, and by the relative spectral light efficiency, S(λ), for the UV radiation.

In addition, the yellowness index YI can be measured in accordance with the standard ASTM D1925.

The invention will now be described in more detail with the help of the following example, which is given solely for illustrative purposes and does not have the aim of limiting the scope of the invention, defined by the appended claims.

### EXAMPLES

### Example 1

### Manufacture of a Lens which Absorbs UV Radiation

A bath was prepared by adding, to 23 l of water, 46 g of sodium dodecylbenzenesulfonate, 200 g of 2-(2-hydroxy-4-octyloxyphenyl)-2H-benzotriazole (Seesorb 707 from Shipro Kasei Kaisha), 4.6 g of a dispersion of blue dye (Teratop Blue NFB from Huntsman) and 2.3 g of a dispersion of red dye (Teratop Red NFR from Huntsman). A lens substrate based on diethylene glycol bis(allyl carbonate) polymer with a refractive index of 1.5 (Orma® from Essilor) was cleaned with isopropyl alcohol and then dip coated in this bath, brought to 94° C., for 45 min. After dipping in the bath, the substrate was cooled and then cleaned by immersing it in isopropyl alcohol for 5 minutes, in order to remove any residual surface deposit. The substrate was subsequently wiped using a rag of Suedine type.

### Example 2

### Measurement of the UV Cutoff

The lens obtained in example 1 was analysed using a spectrophotometer (Cary50). The curve of the percentage of transmission of the lens as a function of the wavelength was plotted. The wavelength corresponding to 1% of transmission, which constitutes the UV cutoff of the material, was subsequently read.

By way of comparison, the UV cutoff of a lens consisting of the same substrate not treated by the UV absorber and of a lens impregnated in the same way with a different UV absorber (UV 24 from Cytec), which is 2,2′-dihydroxy-4-methoxybenzophenone, was also measured.

At the same time, the yellowness index was measured in accordance with the standard ASTM D1925.

For each of the UV absorbers tested, the UV cutoff and the yellowness index were measured on a series of five noncorrecting lenses and the mean of the values obtained was calculated.

The results obtained are collated in the following table:

| Material | UV Cutoff | Yellowness index (YI) |
|---|---|---|
| Orma ® | 355 nm | 0.63 |
| Orma ® + Seesorb 707 | 369 nm | 0.73 |
| Orma ® + UV 24 | 395 nm | 3.35 |

It emerges from the above table that only the lens substrates treated in accordance with the invention simultaneously exhibit a UV cutoff of greater than or equal to 365 nm and a yellowness index YI of less than or equal to 1.5.

1. A process for the manufacture of an ophthalmic lens comprising a transparent organic substrate which absorbs ultraviolet radiation, comprising the dipping of the organic substrate in a bath consisting of an aqueous solution including 2-(2-hydroxy-4-alkyloxyphenyl)-2H-benzotriazole where the alkyl group is linear or branched and includes from 3 to 12 carbon atoms.

2. The process as claimed in claim 1, wherein the alkyl group is a linear or branched alkyl group including from 6 to 10 carbon atoms.

3. The process as claimed in claim 1, wherein the organic substrate is a diethylene glycol bis(allyl carbonate) homopolymer or copolymer.

4. The process as claimed in claim 1, wherein the duration of dipping is between 30 minutes and 3 h.

5. The process as claimed in claim 1, wherein the temperature of the bath is between 80° C. and 99° C.

6. The process as claimed in claim 1, wherein the bath additionally contains at least one additive chosen from the group consisting of: a dispersing agent, a dye, a pigment and their mixtures.

7. The process as claimed in claim 1, wherein the concentration of 2-(2-hydroxy-4-alkyloxyphenyl)-2H-benzotriazole is between 0.1 and 5% by weight, with respect to the total weight of the bath.

8. A method for conferring on an ophthalmic lens, a UV cutoff threshold of greater than or equal to 365 nm and a yellowness index YI of less than or equal to 1.5, comprising dipping an organic substrate in a bath consisting of an aqueous solution including an effective amount of 2-(2-hydroxy-4-alkyloxyphenyl)-2H-benzotriazole where the alkyl group is linear or branched and includes from 3 to 12 carbon atoms.

9. The process as claimed in claim 1, wherein the alkyl group is an octyl group.

10. The process as claimed in claim 1, wherein the temperature of the bath is 90° C. and 96° C.

11. The process as claimed in claim 1, wherein the concentration of 2-(2-hydroxy-4-alkyloxyphenyl)-2H-benzotriazole is between 0.5 and 1% by weight, with respect to the total weight of the bath.

12. The method of claim 8, wherein the yellowness index YI is less than 1.

13. The method of claim 8, wherein the yellowness index YI is less than 0.8.
